(19) United States
(12) Patent Application Publication
(10) Pub. No.: US 2007/0041087 A1
(43) Pub. Date: Feb. 22, 2007

(54) REFLECTOR, LIGHT SOURCE DEVICE, LIQUID CRYSTAL PROJECTOR, AND METHOD FOR DEPOSITING REFLECTING FILM COATINGS

(75) Inventor: Mototaka KANAYA, Tochigi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: FUJINON SANO CORPORATION, Sano-shi (JP)

(21) Appl. No.: 11/461,262

(22) Filed: Jul. 31, 2006

(30) Foreign Application Priority Data
Aug. 19, 2005 (JP) 2005-238202

(51) Int. Cl. F21V 9/04

(52) U.S. Cl. 359/359; 353/98

(57) ABSTRACT

A reflector having a reflecting film coating which is composed of a reduced number of deposition materials and has high resistance to heat, a light source device deposited with such a reflecting film coating, a liquid crystal projector adopting such a light source device, and a method for depositing such a reflecting film coating. The reflector is in the form of a multi-layer reflecting film coating having a low refractive film layer of silicon dioxide laminated alternately with a high refractive film layer of a mixed deposition material containing silicon dioxide along with at least one of high refractive deposition materials such as niobium oxide, tantalum oxide, titanium oxide and zirconium oxide. In forming a high refractive film layer, silicon dioxide, a low refractive deposition material, is mixed into a high refractive deposition material to prevent crystallization of the latter under heated conditions.

### BACKGROUND OF THE INVENTION

1. Field of the Art

This invention relates to a reflector having a reflecting film coating of high heat resistance, a light source device with such a reflecting film coating, a liquid crystal projector incorporating such a light source device, and a method for depositing such reflecting film coatings.

2. Prior Art

As a three-panel type liquid crystal projector, for example, Japanese Laid-Open Patent Application H6-289394 discloses a liquid crystal projector in which light rays from a light source are passed through a condenser lens and then fed to a couple of dichroic mirrors (color separating dichroic mirrors) to separate white light into blue, green and red components. After light modulation by liquid crystal display devices, the respective light components are synthesized into a color image by means of a couple of dichroic mirrors (color synthesizing dichroic mirrors) and projected on a screen by a projection lens.

Because of recent trends of liquid crystal projectors towards larger screens and higher picture quality, there has been a strong demand for high output light source devices. On the other hand, there has been a demand for downsized compact liquid crystal projectors. In order to fulfill these two demands for a light source of high output and compactness in size, it is necessary to provide a light source which is improved as much as possible in efficiency of source light which is projected from the light source.

In this connection, in an attempt to improve luminous efficiency, Japanese Laid-Open Patent Application H6-289394 discloses a light source which employs a reflector thereby to condense light rays which emitted by a luminous source lamp. Even if a reflector of this sort is provided to improve luminous efficiency, losses can still occur to part of light rays which are emitted from a source lamp. In order to suppress light losses as much as possible, a reflecting film coating is deposited on part of a bulb body of the source lamp thereby to reflect light toward a reflector.

When in incandescence, the luminous source lamp reaches an extremely high temperature. Especially, since the light source is required to be of high output as mentioned above, the temperature of the luminous source lamp reaches an extremely high temperature (e.g., in the vicinity of 1,000 degree C.). Higher the temperature of the source lamp, naturally hotter becomes the reflecting film coating which is formed on the source lamp bulb. When heated to an extremely high temperature, surface irregularities may occur to the reflecting film coating due to crystallization, and such surface irregularities tend to scatter incident light to invite degradations in reflection characteristics of the reflecting film coating. In this connection, Japanese Laid-Open Patent Application 2003-240942 describes a method of suppressing thermal degradations in reflection characteristics of a reflecting film coating which would occur when further heated to a high temperature.

Generally, a reflecting film coating is formed by alternately laminating a low refractive film layer and a high refractive film layer on a substrate. In the case of Japanese Laid-Open Patent Application 2003-240942 mentioned above, for the purpose of suppressing degradations in reflection characteristics of a reflecting film coating, a silica glass film layer or a fluorine- or boron-containing silica glass film layer and a bismuth oxide- and/or niobium oxide-containing tantalum oxide film are deposited as low and high refractive film layers, respectively. Therefore, the method of Japanese Laid-Open Patent Application 2003-240942 requires at least three kinds of different deposition materials. Namely, in this case, silica glass is required as a low refractive film deposition material, and at least either bismuth oxide or niobium oxide and tantalum oxide are required as high refractive film deposition materials. Thus, at least three kinds of deposition materials are required in forming a heat resistant reflecting film coating.

By the way, a reflecting film coating can be deposited by various methods including vacuum deposition, ion plating and sputtering. In the case of vacuum deposition, a heating means (e.g., an electron gun) is necessary for heating each deposition material which is respectively filled in crucibles. Ion plating requires an electrode for ionizing evaporated deposition material, while sputtering requires an electrode for producing plasma. Therefore, in order to cope with an increased number of deposition materials, it becomes necessary to provide a complicate deposition system of a larger scale.

### SUMMARY OF THE INVENTION

With the foregoing situations in view, it is an object of the present invention to provide a reflector having a reflecting film coating which is composed of a reduced number of deposition materials and has high resistance to heat, a light source device deposited with such a reflecting film coating, a liquid crystal projector adopting such a light source device, and a method for depositing such a reflecting film coating.

In accordance with the present invention, in order to achieve the above-stated objective, there is provided a reflector in the form of a multi-layer reflecting film coating having a low refractive film layer of silicon dioxide laminated alternately with a high refractive film layer of a mixed deposition material containing silicon dioxide along with at least one of niobium oxide, tantalum oxide, titanium oxide and zirconium oxide.

According to the present invention, there is also provided a light source device comprising a luminous source lamp, a reflector for condensing light emitted by the source lamp, and a multi-layer reflecting film coating deposited on the lamp, characterized in that:

the multi-layer reflecting film coating has a low refractive film layer of silicon dioxide laminated alternately with a high refractive film layer of a mixed deposition material containing silicon dioxide along with at least one of niobium oxide, tantalum oxide, titanium oxide and zirconium oxide.

Further, according to the present invention, there is provided a liquid crystal projector comprising a light source device as set forth in claim 3, liquid crystal display devices for modulating light from the light source, and an optical projection system for projecting light images on a screen.

Further, according to the present invention, there is provided a method for depositing a multi-layer reflecting film coating having alternately a low refractive film layer of silicon dioxide and a high refractive film layer of a mixed deposition material containing silicon dioxide along with at least one of niobium oxide, tantalum oxide, titanium oxide and zirconium oxide, characterized in that the method comprises the steps of: forming a low refractive film layer on a substrate by depositing vapors from an evaporation source of a low refractive deposition material; and forming a high refractive film layer on the substrate by simultaneously depositing vapors from an evaporation source of a high refractive deposition material and vapors from the evaporation source of the low refractive deposition material; repeating deposition of the low refractive film layer alternately with deposition of said high refractive film layer for a predetermined number of times.

The above and other objects, features and advantages of the present invention will become apparent from the following particular description of the invention, taken in conjunction with the accompanying drawings which show by way of example some preferred embodiments of the invention. Needless to say, the present invention is not limited to particular embodiments shown in the drawings.

### BRIEF DESCRIPTION OF THE DRAWINGS

In the accompanying drawings:

FIG. 1 is a schematic view of a liquid crystal projector:

FIG. 2 is a schematic view of a light source device;

FIGS. 3(a) and 3(b) are schematic views explanatory of a vacuum deposition process;

FIG. 4 is a graph of reflection characteristics for an example added with silicon dioxide at a rate of 50%; and

FIG. 5 is a graph of reflection characteristics for a comparative example without silicon dioxide.

### DESCRIPTION OF PREFERRED EMBODIMENTS

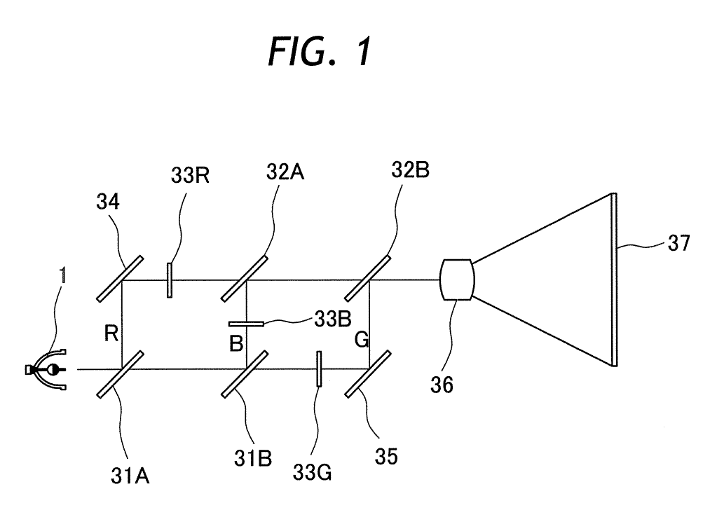

Hereafter, the present invention is described more particular by way of its preferred embodiments with reference to the accompanying drawings. Shown by way of example in FIG. 1 is a three-panel type liquid crystal projector. As seen in FIG. 1, the three-panel type liquid crystal projector is largely constituted by color separating dichroic mirrors 31A and 31B, color synthesizing dichroic mirrors 32A and 32B, liquid crystal display devices 33R, 33G and 33B, reflector mirrors 34 and 35, projection lens 36, and projection screen 37. Firstly, a red component is separated by the color separating dichroic mirror 31A from other color components of white light from a luminous light bulb of a light source device 1, and then blue and green components are separated by the color separating dichroic mirror 31B.

Of the color components which are separated by the color separating dichroic mirrors 31A and 31B, the red and green light components are reflected off the reflector mirror 35 to change the light path. Then, the separated red, green and blue light components are projected on the liquid crystal display devices 33R, 33G and 33B for light modulation, respectively. Light-modulated red and blue components from the liquid crystal display devices 33R and 33B are synthesized at the color synthesizing dichroic mirror 32A, and, at the color synthesizing dichroic mirror 32B, synthesized light of the red and blue components is then synthesized with the light-modulated green component from the liquid crystal display device 33G. The resulting synthesized light image is projected on a screen 37 by the projection lens 36. Of course, in addition to the liquid crystal projector which is shown in FIG. 1 as a typical example, the present invention can be applied arbitrarily to other liquid crystal projectors.

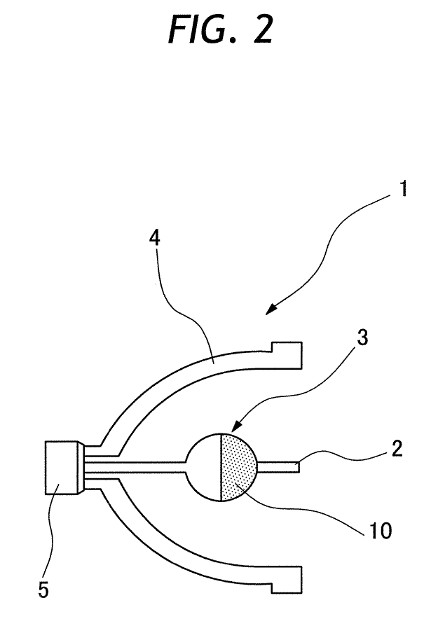

Shown in FIG. 2 is a light source device for a liquid crystal projector. As shown in FIG. 2, the light source device 1 is constituted by a luminous source lamp 2 which is largely composed of a transparent glass tube and a reflector 4. The luminous source lamp 2 includes a luminous bulb portion 3 which houses an incandescent substance and electrodes which are not shown. The reflector 4 is a member which serves to reflect and condense light rays which are emitted from the bulb portion 3 of the source lamp 2. For the purpose of condensing light rays from the luminous bulb portion 3, the reflector 4 is formed in a semi-elliptical shape thereby to condense reflected light toward one point. Further, for enhancing light reflection rate, a reflecting film coating 10 is deposited on the bulb portion 3 of the lamp 2. Namely, the reflecting film coating 10 on the bulb portion 3 of the source lamp 2 serves to reflect toward the reflector 4 part of light rays which are emitted from the bulb portion 3 but not condensed by the reflector 4. (In the case of FIG. 2, the reflecting film coating 10 is disposed face to face with the reflector 4.) Base ends of the source lamp 2 and reflector 4 are fixed in an annular anchor metal piece 5.

In this instance, the reflecting film coating 10 is formed by alternately laminating a high refractive film layer and a low refractive film layer. As deposition material for the high refractive film layer, tantalum oxide, niobium oxide, titanium oxide or zirconium oxide can be suitably used, while, as deposition material for the low refractive film layer, silicon dioxide can be suitably used. Of the deposition materials just mentioned, silicon dioxide for the low refractive film layer has excellent properties in heat resistance but the substances for the high refractive film layer have such problematic properties that crystallization occurs internally of the film layer when heated to a high temperature. That is to say, when subjected to a high temperature of incandescence, regular arrays of columnar crystals appear internally of high refractive film layers, giving rise to ups and downs on the surface of film layers.

The reflecting film coating 10, which is formed on the bulb portion 3 as described above, is heated to an extremely high temperature when the source lamp is in incandescence. Especially, in case the light source device 1 is of high output, the reflecting film coating 10 on the bulb portion 3 is put in an extremely heated state. Therefore, when in an extremely heated state, crystallization occur to the high refractive film layers of the reflecting film coating 10, and as a result incident light rays are scattered by ups and downs which appear on the surface of the high refractive film layers to degrade the refractive of the reflecting film coating 10, namely, to lower the luminous efficiency of the source light to a considerable degree.

This problem can be coped with by mixing silicon dioxide (a deposition material normally used for a low refractive film layer) into a high refractive film deposition material such as tantalum oxide, niobium oxide, titanium oxide or zirconium oxide in forming the high refractive film layer, instead of forming the high refractive film layer by the use of a high refractive film deposition material alone. For example, in case niobium oxide is selected as a high refractive film deposition material, a multi-layered reflecting film coating 10 is deposited by alternately laminating a high refractive film layer, which is formed of a mixture of niobium oxide and silicon dioxide, and a low refractive film layer which is formed of silicon dioxide alone. In case a high refractive film layer is formed of a mixture of a high refractive film deposition material and a low refractive film deposition material like silicon dioxide, the mixed low refractive film deposition material acts to prevent crystallization of the high refractive film deposition material (prevent the high refractive film deposition material from being oriented in a regular form), so that crystallization does not take place even when the high refractive film to a normally crystallizing temperature.

In case a high refractive film layer is formed of a mixture of a high refractive film deposition material (e.g., niobium oxide) and a low refractive film deposition material (silicon dioxide), the resulting film layer has a dropped refractive as compared with a film layer which is formed of niobium oxide alone. That is to say, more or less the reflecting film coating 10 is degraded in reflection characteristics. Of course, it is possible to improve the refractive by increasing the number of film layers of the reflecting film coating 10, but deposition of a greater number of film layers requires a process which is disadvantageously more demanding in time and cost. For this reason, it is not desirable to mix silicon dioxide into a high refractive film deposition material at a high rate. On the other hand, a reduction of the proportion of a low refractive film deposition material may make it difficult to prevent crystallization of a high refractive film deposition material. Taking these into consideration, it is preferable to mix silicon dioxide into a high refractive film deposition material at a rate of 10% to 50%.

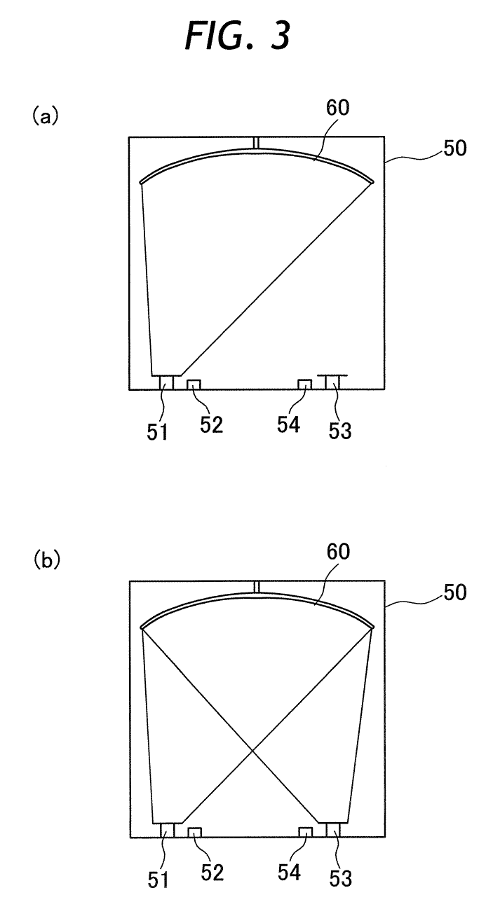

There are a variety of methods for depositing the reflecting film coating 10 on the bulb portion 3 of the source lamp 2. Shown in FIGS. 3(a) and 3(b) is a vacuum deposition method which can be adopted for depositing the reflecting film coating 10. In this instance, niobium oxide and silicon dioxide are exemplified as high refractive film deposition material and low refractive film deposition material, respectively. Of course, in place of niobium oxide, tantalum oxide, titanium oxide or zirconium oxide may be employed as a high refractive film deposition material. Further, instead of vacuum deposition, the reflecting film coating 10 may be deposited by other deposition method such as sputtering and ion plating.

Shown in FIGS. 3(a) and 3(b) is a vacuum evaporator 50 which is provided with a couple of evaporation sources 51 and 53 and a couple of electron guns 52 and 54 within a vacuum chamber. As mentioned above, the reflecting film coating 10 is composed of low refractive film layers which are formed of silicon dioxide, and high refractive film layers which are formed of a mixture of niobium oxide and silicon dioxide. Since the reflecting film coating 10 is formed of two kinds of deposition materials, the vacuum evaporator 50 suffice to have only two evaporation sources within a vacuum chamber. In this instance, the evaporation source 51 is filled with silicon dioxide while the other evaporation source 53 is filled with niobium oxide. The deposition materials in the evaporation sources 51 and 53 are heated and evaporated by the electron guns 52 and 54, respectively. An alternative deposition material can be evaporated in case the evaporation source 53 is filled with an alternative deposition material such as tantalum oxide, titanium oxide or zirconium oxide in place of niobium oxide.

A rotatable dome 60 is attached to the ceiling of the vacuum chamber to support thereon bulb portions 3 of a plural number of source lamps 2. The deposition materials which are evaporated by the evaporation sources 51 and 53 at the bottom of the vacuum evaporator 50 are deposited on the bulb portions 3 which are set on the dome 60. More specifically, a low refractive film layer and a high refractive film layer are alternately laminated to form a reflecting film coating 10 on each bulb portion 3 of a source lamp 2. The low refractive film layer consists of a film of silicon dioxide alone, while the high refractive film layer consists of a film of a mixture of niobium oxide with silicon dioxide. Thus, the low refractive film layer and high refractive film layer are deposited in a different way from each other.

Namely, at the time of depositing a low refractive film layer on bulb portions 3 on the dome 60, the deposition material in the evaporation source 51 is evaporated to deposit silicon dioxide alone as shown in FIG. 3(a). On the other hand, at the time of depositing a high refractive film layer on the bulb portion 3, two kinds of deposition materials in the evaporation sources 51 and 53 are simultaneously evaporated as shown in FIG. 3(b) to deposit niobium oxide and silicon dioxide in a mixed state. Silicon dioxide and niobium oxide which are evaporated respectively from the evaporation sources 51 and 53 are mixed in vacuum and deposited on bulb portions 3 in a mixed state. A cycle of low refractive film deposition and a cycle of high refractive film deposition are repeated alternately to deposit reflecting film coatings 10 on bulb portions.

In this instance, mixed film layers are deposited by evaporating different deposition materials from two evaporation sources. However, it is also possible to deposit a mixed film layer, for example, by the use of a mixed deposition material which contains silicon dioxide and niobium oxide in a predetermined ratio. From the standpoint of simplicity of the deposition process, it is advantageous to evaporate deposition materials simultaneously from two evaporation sources than preparing a mixed deposition material of silicon dioxide and niobium oxide beforehand.

Instead of the vacuum deposition shown in FIG. 3, the reflecting film coating 10 can be deposited by a sputtering method, depositing a coating on a substrate by using low and high refractive film targets in place of the evaporation sources 51 and 53 and the electron guns 52 and 54 and applying an electric voltage to the targets. In case of ion plating, it is necessary to provide a plasma generating device in addition to evaporation sources 51 and 53 and electron guns 52 and 54 as used in the vacuum deposition process. Namely, in the case of a sputtering method or an ion plating method, of the two evaporation sources which are filled with silicon dioxide and niobium oxide, respectively, silicon dioxide alone is evaporated from its evaporation source at the time of depositing a low refractive film layer on a substrate, and both silicon dioxide and niobium oxide are evaporated from the respective evaporation source at the time of depositing a high refractive film layer on the substrate.

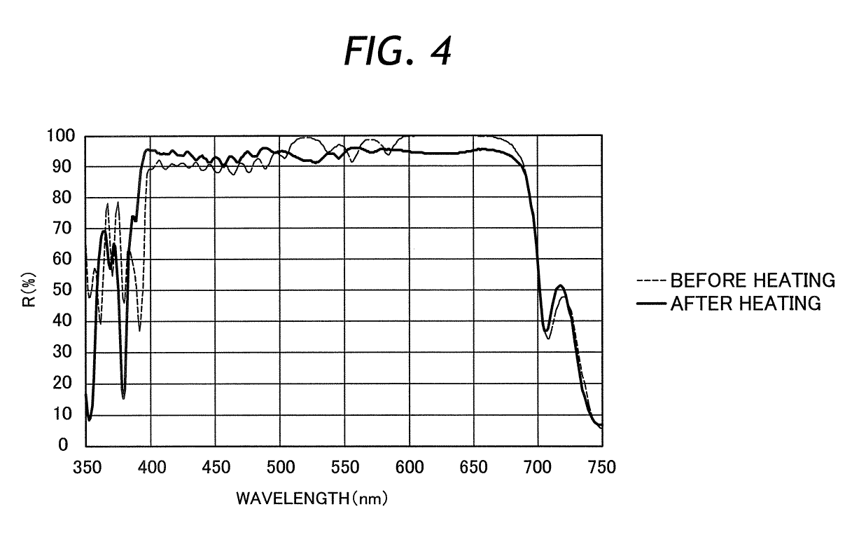

Now, reference is had to FIG. 4 to explain reflection characteristics of the reflecting film coating 10 which is formed by alternately laminating a low refractive film layer of silicon dioxide and a high refractive film layer of a mixture of niobium oxide and silicon dioxide as described above. More particularly, plotted on the graph of FIG. 4 are reflection characteristics of a reflecting film coating 10 having silicon dioxide mixed with niobium oxide at a rate of 50%. In the graph of FIG. 4, broken line indicates reflection characteristics of the reflecting film coating 10 before a heating test, that is to say, reflection characteristics at room temperature, while solid line indicate reflection characteristics of the reflecting film coating 10 after heating. As seen in FIG. 4, in a wavelength range of from 400 nm to 700 nm (a wavelength range used by liquid crystal projectors), reflection characteristics of the reflecting film coating 10 before heating are in a range between 90% and 100%, while reflection characteristics of the reflecting film coating 10 after heating are also in a range between 90% and 100%. That is to say, the reflecting film coating retains high reflection characteristics even after heating thanks to silicon dioxide which is mixed into high refractive film layers of niobium oxide to prevent crystallization of the latter. Thus, the reflection characteristics remains substantially the same even after the reflecting film coating 10 is heated. In this instance, the reflecting film coating 10 is constituted by 60 film layers. High reflection characteristics as described above can be obtained even in a heated state when silicon dioxide is mixed at a rate of 50%. However, satisfactory high reflection characteristics can be obtained as long as silicon dioxide is mixed at a rate in the range of 10% to 50%.

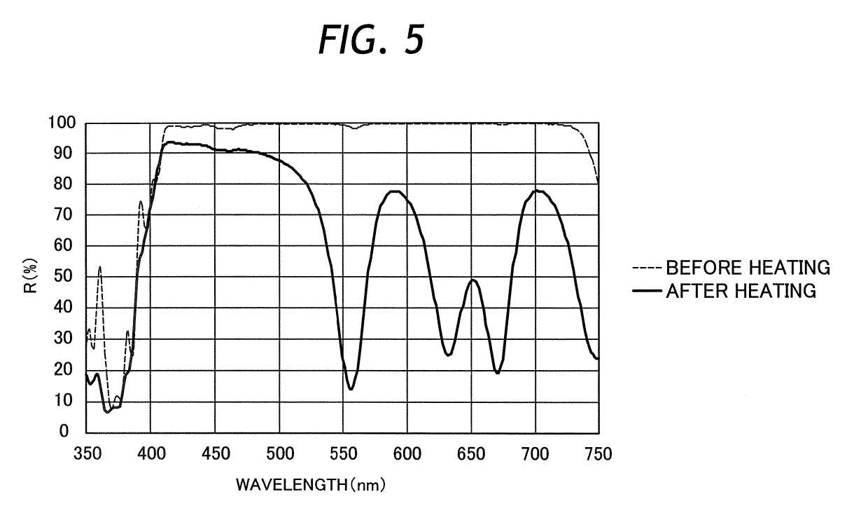

Shown in FIG. 5 is a graph showing reflection characteristics before and after a heating test, for a comparative example having no silicon dioxide mixed into high refractive film layers (i.e., a comparative example having high refractive film layers of niobium oxide alone). As shown in FIG. 5, the reflection characteristics of the comparative example is almost 100% before heating, but the reflection characteristics drop to a considerable degree after heating. Namely, in the case of a high refractive film layer without silicon dioxide, niobium oxide undergoes crystallization upon heating, giving rise to ups and downs on the surface of the film layer and as a result degrading reflection characteristics to a considerable degree by scattering light. In the case of the comparative example shown, the reflecting film coating is constituted by 43 film layers.

As explained above, the reflecting film coating according of the present invention, in depositing high refractive film layers, silicon dioxide, which is a low refractive film deposition material, is mixed into a high refractive film deposition material such as tantalum oxide, niobium oxide, titanium oxide or zirconium oxide thereby to prevent crystallization of high refractive film layers in the reflecting film coating. Thus, the present invention obviates thermal degradations in reflection characteristics of a reflecting film coating which is deposited on a source lamp of a liquid crystal projector for the purpose of enhancing light condensing rate. It follows that, according to the present invention, it becomes possible to produce a reflector with a reflecting film coating of high thermal resistance by the use of a reduced number of deposition materials.

In this instance, by mixing silicon dioxide (a low refractive film deposition material) into a high refractive film deposition material like niobium oxide, a thermally resistant reflecting film coating can be formed by the use of a minimum number of deposition materials, that is, by the use of only two kinds of deposition materials. This means that, in the case of vacuum deposition or ion plating process, the number of evaporation sources as well as the number of electron guns to be provided within a vacuum evaporator can be suppressed to two. Further, in the case of a sputtering process, it becomes possible to reduce the number of electrodes (cathodes) which are required for creating plasma, preventing complication and up-sizing of deposition apparatus.

What is claimed is:

1. A reflector in the form of a multi-layer reflecting film coating having a low refractive film layer of silicon dioxide laminated alternately with a high refractive film layer of a mixed deposition material containing silicon dioxide along with at least one of niobium oxide, tantalum oxide, titanium oxide and zirconium oxide.

2. A reflector as defined in claim 1, wherein high refractive film layers of said reflecting film coating contain silicon dioxide at a rate in a range of between 10% and 50%.

3. A light source device comprising an incandescent source lamp, a reflector for condensing light emitted by said source lamp, and a multi-layer reflecting film coating deposited on said lamp, characterized in that:
said multi-layer reflecting film coating has a low refractive film layer of silicon dioxide laminated alternately with a high refractive film layer of a mixed deposition material containing silicon dioxide along with at least one of niobium oxide, tantalum oxide, titanium oxide and zirconium oxide.

4. A liquid crystal projector comprising a light source device as set forth in claim 3, liquid crystal display devices for modulating light from said light source, and an optical projection system for projecting light images on a screen.

5. A method for depositing a multi-layer reflecting film coating having alternately a low refractive film layer of silicon dioxide and a high refractive film layer of a mixed deposition material containing silicon dioxide along with at least one of niobium oxide, tantalum oxide, titanium oxide and zirconium oxide, characterized in that said method comprises the steps of:
forming a low refractive film layer on a substrate by depositing vapors from an evaporation source of a low refractive deposition material; and
forming a high refractive film layer on said substrate by simultaneously depositing vapors from an evaporation source of a high refractive deposition material and vapors from said evaporation source of said low refractive deposition material;
repeating deposition of said low refractive film layer alternately with deposition of said high refractive film layer for a predetermined number of times.

6. A method for depositing a multi-layer reflecting film coating as defined in claim 5, wherein said low and high refractive film layers are deposited by vacuum deposition, ion plating or sputtering.
